(19) United States
(12) Patent Application Publication
(10) Pub. No.: US 2026/0054496 A1
(43) Pub. Date: Feb. 26, 2026

(54) DEGASSING DEVICE AND INKJET RECORDING APPARATUS

(71) Applicant: KYOCERA Document Solutions Inc., Osaka (JP)

(72) Inventor: Hideki ISHIDA, Osaka-shi (JP)

(73) Assignee: KYOCERA Document Solutions Inc., Osaka (JP)

(21) Appl. No.: 18/810,326

(22) Filed: Aug. 20, 2024

(51) Int. Cl. B41J 2/19; B41J 2/175

(52) U.S. Cl. CPC B41J 2/19; B41J 2/17596

(57) ABSTRACT

A degassing device removes air dissolved in liquid under a pressure decreased atmosphere. The degassing device includes a liquid tank, a pressure decreasing device, a circulation flow pass, and a control device. The liquid tank stores the liquid. The pressure decreasing device decreases pressure in the liquid tank. The circulation flow pass communicates different positions of the liquid tank. The circulation device circulates the liquid through the circulation flow pass. The control device drives the circulation device at least one of timing before driving the pressure decreasing device and timing before releasing the pressure decreased liquid tank to the atmosphere.

### BACKGROUND

The present disclosure relates to a degassing device and an inkjet recording apparatus.

In an inkjet recording apparatus, when an amount of dissolved gas of ink increases, bubbles may be generated inside a recording head, causing an ejection failure. Therefore, a technique for decreasing an amount of the dissolved gas in the ink has been studied. For example, there has been proposed a configuration in which the ink in the ink tank is stirred to degas the ink in a state where a pressure inside an ink tank is decreased.

In the above degassing device, the ink in the ink tank is stirred, and the ink is degassed near the liquid surface. However, since the stirrer is located at the bottom of the ink tank, when the ink capacity increases, it becomes difficult to replace the ink near the liquid surface where an amount of dissolved air is small with the ink near the bottom surface where an amount of dissolved air is large, and the degassing efficiency is lowered. In addition, the degassing device may be applied with a load by the pressure decreasing, the durability may be lowered.

### SUMMARY

A degassing device according to the present disclosure removes air dissolved in liquid under a pressure decreased atmosphere. The degassing device includes a liquid tank, a pressure decreasing device, a circulation flow pass, and a control device. The liquid tank stores the liquid. The pressure decreasing device decreases pressure in the liquid tank. The circulation flow pass communicates different positions of the liquid tank. The circulation device circulates the liquid through the circulation flow pass. The control device drives the circulation device at least one of timing before driving the pressure decreasing device and timing before releasing the pressure decreased liquid tank to the atmosphere.

An inkjet recording apparatus according to the present disclosure includes the degassing device according to claim 1, a recording head which ejects the liquid degassed by the degassing device, to a sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view showing an inkjet recording apparatus according to one embodiment of the present disclosure.

FIG. 2 is a schematic view showing an ink supply configuration according to the embodiment of the present disclosure.

FIG. 3 is a sectional view schematically showing a degassing device according to the embodiment of the present disclosure.

FIG. 4 is a flowchart explaining a total operation of the degassing device according to the embodiment of the present disclosure.

FIG. 5 is a flowchart explaining a pressure decreasing operation of the degassing device according to the embodiment of the present disclosure.

FIG. 6 is a flowchart explaining a degassing operation of the degassing device according to the embodiment of the present disclosure.

### DETAILED DESCRIPTION

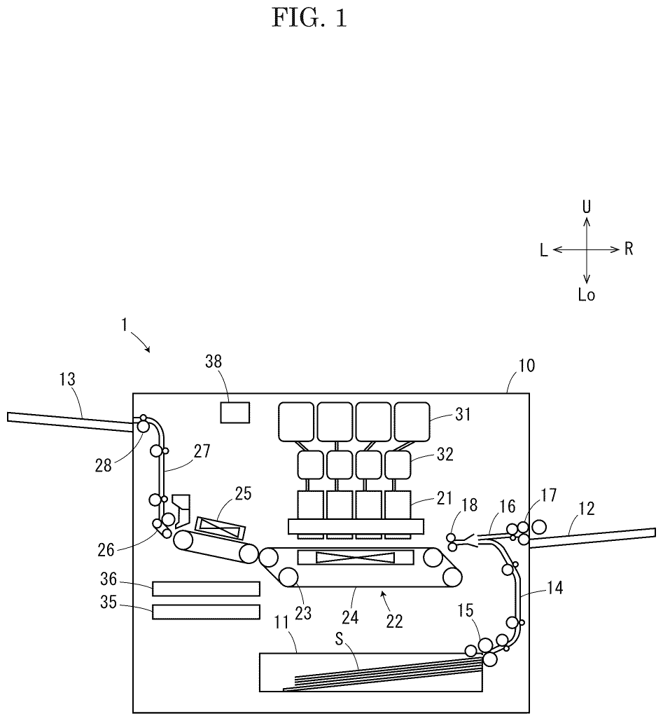

Hereinafter, with reference to the drawings, an inkjet recording apparatus 1 of the present embodiment will be described. FIG. 1 is a schematic view showing the inkjet recording apparatus 1 according to the present embodiment. For convenience of explanation, the front side of the paper surface on which FIG. 1 is drawn is defined as the front side of the inkjet recording apparatus 1, and the left-and-right direction will be described with reference to the direction in which the inkjet recording apparatus 1 is viewed from the front side. The arrows L, R, U, and Lo attached to each figure indicate the left, right, upper, and lower sides of the inkjet recording apparatus 1, respectively.

An inkjet recording apparatus 1 ejects ink from each inkjet recording head 21 toward a sheet S as a recording medium and performs printing. The inkjet recording apparatus 1 includes a box-shaped housing 10 in which various kinds of device are housed. In the lower portion of the housing 10, a sheet feeding cassette 11 in which the sheet S is set is housed, and a manual sheet feeding tray 12 on which the sheet S is set by hand is installed on the right side surface of the housing 10. On the upper portion of the left side surface of the housing 10, a sheet discharge tray 13 on which the recorded sheet S is stacked is installed.

In the right side portion in the housing 10, a first conveyance path 14 along which the sheet S is conveyed from the sheet feeding cassette 11 to the recording head 21 provided in the center of the housing 10 is formed. On the upstream side of the first conveyance path 14, a first sheet feeding part 15 which feeds the sheet S from the sheet bundle in the sheet feeding cassette 11 is provided, and a registration roller 18 which adjusts the feeding timing of the sheet S is provided in the downstream portion of the first conveyance path 14. Further, a sheet feeding path 16 of the manual sheet feeding tray 12 is merged with the downstream portion of the first conveyance path 14, and a second sheet feeding part 17 which feeds the sheet S from the sheet bundle on the manual sheet feeding tray 12 is provided on the sheet feeding path 16.

On the downstream side of the registration roller 18, a conveying device 22 and the recording head 21 provided for each color (for example, black, cyan, magenta, and yellow) are installed. The registration roller 18 corrects the skew of the sheet S and then sends the sheet S to the conveying device 22 in accordance with the ink ejecting operation by each recording head 21. In the housing 10, an ink container 31 and an ink tank 32 for each recording head 21 are provided. The ink of each ink container 31 is temporarily stored in the ink tank 32, the ink is degassed as necessary, and then the ink is supplied from the ink tank 32 to the recording head 21.

The conveying device 22 is constituted by winding a conveyance belt 24 around a plurality of tension rollers 23 installed below the recording heads 21. On the downstream side of the conveying device 22, a drying device 25 which dries the ink of the sheet S is provided. On the downstream side of the drying device 25, a decurl device 26 which corrects the curl generated on the sheet S by drying the ink is provided. On the downstream side of the decurl device 26, a second conveyance path 27 along which the sheet S is conveyed toward the sheet discharge tray 13 is formed. In the downstream portion of the second conveyance path 27, a sheet discharge part 28 which discharges the recorded sheet S to the sheet discharge tray 13 is provided.

Below the drying device 25, a maintenance unit 35 which cleans the recording heads 21 and a cap unit 36 which caps the recording heads 21 are provided. The maintenance unit 35 is provided with a squeegee-shaped wiping blade, and the wiping blade scrapes the ink remaining on the nozzle surface of the recording head 21. The cap unit 36 is provided with a head cap, and the nozzle surface of the recording head 21 is capped with the head cap. The head cap suppresses drying of the ink in the nozzle. The drying of the ink in the nozzle may be further suppressed by storing a liquid such as a cleaning liquid in the head cap.

Further, the inkjet recording apparatus 1 is provided with a control device 38 for controlling the entire apparatus. The control device 38 may be composed of a processor or a logic circuit (hardware) formed in an integrated circuit or the like. In the case of a processor, the processor reads and executes a program stored in a memory, and various processes are executed. For example, a CPU (Central Processing Unit) is used as the processor. The memory is constituted by one or more storage devices such as a ROM (Read Only Memory), a RAM (Random Access Memory) or the like depending on the application.

At the time of image recording, the sheet S is fed from the sheet feeding cassette 11 and the manual sheet feeding tray 12 by the first sheet feeding part 15 and the second sheet feeding part 17, respectively, and then sent to the registration roller 18. In accordance with the ejecting timing of the ink, the sheet S is conveyed from the registration roller 18 to the conveyance belt 24, the degassed ink is ejected from each recording head 21, and a color image is recorded on the surface of the sheet S. The sheet S is dried by the drying device 25, and the curl of the sheet S is corrected by the decurl device 26. The sheet S is conveyed to the sheet discharge part 28 through the second conveyance path 27, and the recorded sheet S is discharged to the sheet discharge tray 13 by the sheet discharge part 28.

By the way, the liquid surface of the ink touches the air in the ink tank 32, and the dissolving of the air proceeds, and the nozzle of the recording head 21 may be clogged by bubbles in the ink. Therefore, it is desired to appropriately keep an amount of dissolved gas in the ink. For example, a method has been proposed in which by passing the ink through the hollow fiver filter in a state where the pressure of the circumference of the hollow fiber filter is decreased, the air is moved from the wall surface of the hollow fiber to the pressure decreased side to degas the ink. This method requires the expensive hollow fiber filter and requires periodic replacement operations, which increase cost.

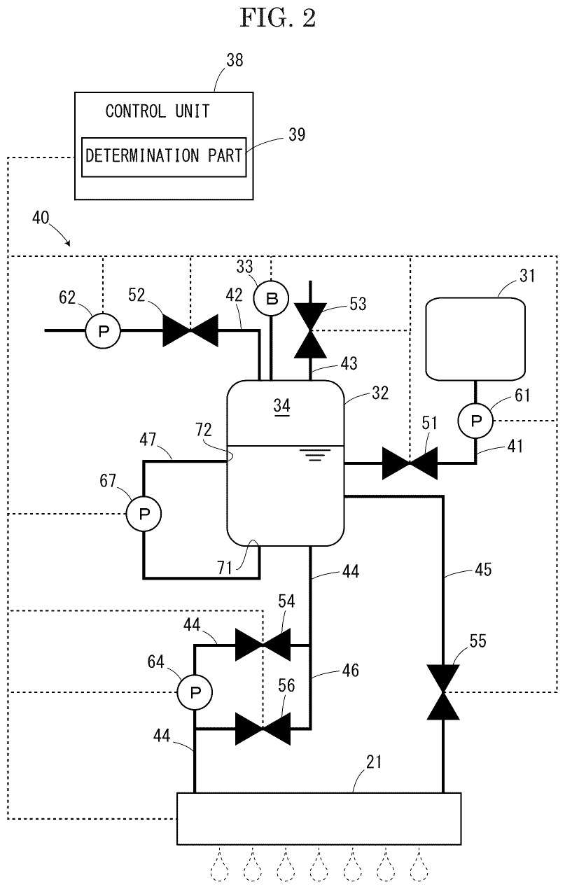

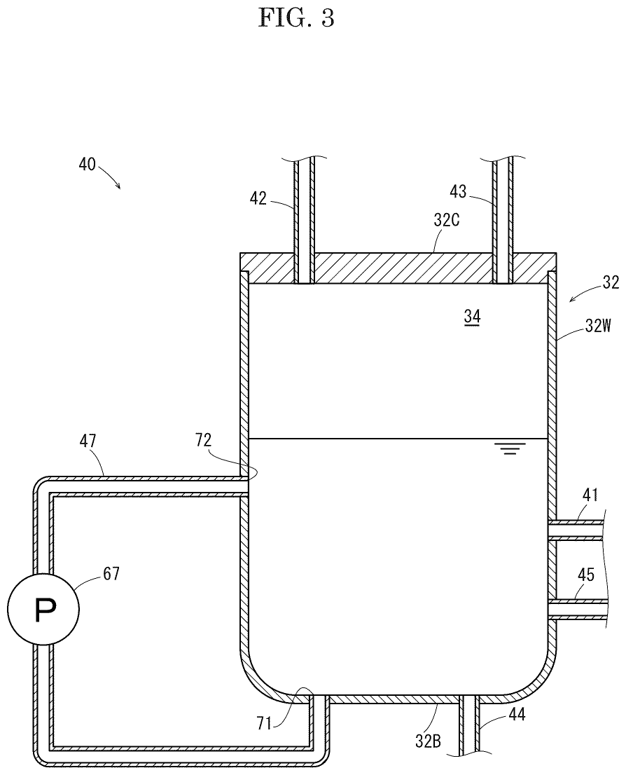

In order to prevent the clogging of the nozzle, a method (hereinafter referred to as the stirring degassing method) has been proposed in which the ink is stirred by the stirrer in a state in which the pressure in the ink tank 32 is decreased below an atmospheric pressure to degas the ink. In the stirring degassing method, a magnetic force is externally applied to the stirrer in the ink tank 32, and the stirrer is rotated by the magnetic force to stir the ink in the ink tank 32. When the depth of the ink and the tank diameter are large, the ink is difficult to be stirred, and the degassing efficiency is lowered. As the rotational speed of the stirrer is increased, the stirring becomes easier, but when the rotational speed of the stirrer becomes too high, a detuning phenomenon occurs and the rotational sound of the stirrer becomes large. Therefore, in the present embodiment, a circulation degassing method shown below is adopted.

[Degassing Device] A degassing device 40 according to this embodiment will be described. FIG. 2 is a schematic diagram showing an ink supply configuration according to the present embodiment. FIG. 3 is a cross-sectional view schematically showing the degassing device 40. Although the inkjet recording apparatus 1 according to the present embodiment is provided with the ink supply configuration for each color of the ink, one ink supply configuration will be described here because these ink supply configurations have the same structure.

[Ink Tank] The ink tank 32 has a cylindrical side wall portion 32W whose axial direction is along the upper-and-lower direction, a bottom portion 32B for closing the lower end portion of the side wall portion 32W, and a lid body portion 32C for closing the upper end portion of the side wall portion 32W. The horizontal cross section of the inner surface of the side wall portion 32W is preferably circular. Preferably, the side wall portion 32W and the bottom portion 32B are integrally formed.

[Replenishment Flow Pass] A replenishment flow pass 41 communicates with the ink container 31 and the ink tank 32. One end portion of the replenishment flow pass 41 is connected to the side wall portion 32W of the ink tank 32 below the liquid surface. On the replenishment flow pass 41, a replenishment pump 61 and a replenishment valve 51 are provided.

[Air Release Flow Pass] An air release flow pass 43 is connected to the lid body portion 32C, and communicates with the upper space 34 of the ink tank 32. On the air release flow pass 43, an air release valve 53 is provided.

[Pressure Decreasing Flow Pass] A pressure decreasing flow pass 42 is connected to the lid body portion 32C, and communicates with the upper space 34 of the ink tank 32. On the pressure decreasing flow pass 42, a pressure decreasing pump 62 and a pressure decreasing valve 52 are provided.

[Supply Flow Pass] A supply flow pass 44 communicates with the ink tank 32 and the recording head 21. One end portion of the supply flow pass 44 is connected to the bottom portion 32B of the ink tank 32. On the supply flow pass 44, a supply valve 54 and a supply pump 64 are provided.

[Recovery Flow Pass] A recovery flow pass 45 communicates with the ink tank 32 and the recording head 21. One end portion of the recovery flow pass 45 is connected to the side wall portion 32W of the ink tank 32. On the recovery flow pass 45, a recovery valve 55 is provided.

[Bypass Flow Pass] The supply flow pass 44 includes a bypass flow pass 46 bypassing the supply valve 54 and the supply pump 64. On the bypass flow pass 46, a bypass valve 56 is provided.

[Circulation Flow Pass] A circulation flow pass communicates with the vicinity of the bottom surface of the ink of the ink tank 32 and the vicinity of the liquid surface. The circulation flow pass 47 has an outlet port 71 through which the ink flows out from the ink tank 32 into the circulation flow pass 47, and an inlet port 72 through which the ink flows in from the circulation flow pass 47 into the ink tank 32. The outlet port 71 is connected to the bottom portion 32B of the ink tank 32, and the inlet port 72 is connected to the side wall portion 32W of the ink tank 32 at a position near the liquid surface. That is, the inlet port 72 is positioned higher than the outlet port 71. On the circulation flow pass 47, a circulation pump 67 is provided. The ink is circulated via the circulation flow pass 47 by the circulation pump 67.

[Circulation Pump] As a pump usable for a circulation pump 67, a non-positive displacement pump such as a centrifugal pump, an oblique flow pump, and an axial flow pump, a positive displacement rotary pump such as a vane pump, a gear pump, a screw pump, and a perista pump (a tube pump), and a reciprocation displacement pump such as a piston pump, a plunger pump, and a diaphragm pump are known. Of these, the non-positive displacement pump, the rotary pump other than the perista pump, and the reciprocation pump other than the diaphragm pump have the advantage that they are not affected by the pressure decreasing when the ink tank 32 is decreased in pressure. On the other hand, the perista pump and the diaphragm pump are easily affected by the pressure decreasing but have the advantage of being inexpensive. In this embodiment, the perista pump or the diaphragm pump is employed as the circulation pump 67. Countermeasures against the effect of pressure decreasing will be described later.

In general, the recording head 21 may be included in the circulation flow pass 47 of the circulation degassing method, but in the present embodiment, the recording head 21 is not included in the circulation flow pass 47. That is, the circulation flow pass 47 is provided separately from the pass for supplying the ink to the recording head 21. Since the recording head 21 is not included in the circulation flow pass 47, the possibility that the meniscus formed in the nozzle of the recording head 21 is broken by the decreased pressure during the degassing and the outside air enters the recording head 21 can be reduced.

[Control Device] The replenishment pump 61, the pressure decreasing pump 62, the supply pump 64, the circulation pump 67, the replenishment valve 51, the pressure decreasing valve 52, the air release valve 53, the supply valve 54, the recovery valve 55, and the bypass valve 56 are controlled by the control device 38. The control device 38 includes a determination part 39 which determines the necessity of the degassing operation in accordance with a leaving time of the ink. When the determination part 39 determines that degassing of the ink is unnecessary, the degassing operation is not performed. Even if the air is dissolved again by leaving the ink, the ink can be used without the degassing within the allowable time.

[Barometer] The ink tank 32 is provided with a barometer 33 which measures an atmospheric pressure in the upper space 34 of the ink tank 32. The control device 38 acquires atmospheric pressure data from the barometer 33.

Next, the basic operation of the degassing device 40 will be described. Here, the standby state will be described as an initial state.

[Standby State] In the standby state, the replenishment valve 51, the pressure decreasing valve 52, and the supply valve 54 are closed, and the air release valve 53, the recovery valve 55, and the bypass valve 56 are opened. The ink is stored in the ink tank 32, the liquid surface is exposed to the air in the upper space 34 opened to the atmosphere, and then the air is dissolved in the ink with the lapse of time.

In the standby state, the determination part 39 of the control device 38 determines whether the degassing is necessary. For example, the control device 38 is provided with a timer, and the leaving time of the ink is measured by the timer. An amount of dissolved gas of the ink can be estimated from one or more parameters such as an atmospheric pressure, a temperature of the ink, and an elapsed time from the last printing. Therefore, the determination part 39 stores conversion information indicating a correspondence relationship between each parameter and the amount of dissolved gas of the ink, and estimates the amount of dissolved gas of the ink based on each parameter. In addition, the determination part 39 stores conversion information indicating a correspondence relationship between the amount of dissolved gas of the ink and the allowable time, and the allowable time is set based on the amount of dissolved gas of the ink. The allowable time is a time during which the printing is allowed without degassing even if the ink is left. For the conversion information indicating the correspondence relationship between each parameter and the amount of dissolved gas of the ink and the conversion information indicating the correspondence relationship between the amount of dissolved gas of the ink and the allowable time, map data, a lookup table, a conversion equation, and the like are used. These map data, lookup table, and conversion equation are obtained experimentally, empirically, and theoretically in advance.

When the leaving time of the ink is within the allowable time, the determination part 39 determines that the degassing is unnecessary because an oxygen saturation degree is low. When the leaving time of the ink exceeds the allowable time, the determination part 39 determines that the degassing is necessary because the oxygen saturation degree is high. If the degassing is necessary, the control device 38 performs the pressure decreasing process and the degassing process described below.

[Pressure Decreasing Process] In the pressure decreasing process, the control device 38 closes the replenishment valve 51, the air release valve 53, the supply valve 54, the recovery valve 55, and the bypass valve 56, opens the pressure decreasing valve 52, and drives the pressure decreasing pump 62. Then, the air is sucked out from the upper space 34 of the ink tank 32, and the upper space 34 is decreased in pressure. The control device 38 stops the pressure decreasing pump 62 when the atmospheric pressure in the upper space 34 indicated by the barometer 33 reaches a target value (for example, −50 [kPa]).

[Degassing Process] When the pressure decreasing process is completed, the control device 38 performs the degassing process. In the degassing process, the control device 38 closes the replenishment valve 51, the pressure decreasing valve 52, the air release valve 53, the supply valve 54, the recovery valve 55, and the bypass valve 56, and drives the circulation pump 67 for a predetermined period. When the circulation pump 67 is driven, the ink in the ink tank 32 circulates through the circulation flow pass 47. The ink near the bottom surface of the ink tank 32 having a large amount of dissolved air flows out into the circulation flow pass 47 through the outlet port 71, and the ink in the circulation flow pass 47 flows into the vicinity of the liquid surface in the ink tank 32 through the inlet port 72. The liquid surface of the ink is exposed to the pressure decreased atmosphere to remove the air dissolved in the ink near the liquid surface. By smoothly replacing the ink near the liquid surface having a small amount of dissolved air with the ink near the bottom surface having a large amount of dissolved air, the degassing efficiency is improved. In addition, unlike the stirring degassing method, the depth of the ink and the tank diameter are not affected, and the driving sound of the circulation pump 67 is suppressed rather than the rotating sound of the stirrer, and the quietness is enhanced.

[Head Circulation Process] The head circulation process may be performed before or after the degassing process and may be performed at a unique timing. In the head circulation process, the control device 38 closes the replenishment valve 51, and the bypass valve 56, opens the air release valve 53, the supply valve 54, and the recovery valve 55, and drives the supply pump 64. Then, the ink is supplied from the ink tank 32 to the recording head 21 through the supply flow pass 44, and the ink is recovered from the recording head 21 to the ink tank 32 through the recovery flow pass 45. By circulating the ink between the recording head 21 and the ink tank 32, the ink with increased viscosity is replaced in the recording head 21 and bubbles are removed from the recording head 21.

[Print Process] In the printing operation by the recording head 21, the replenishment valve 51, the pressure decreasing valve 52 and the supply valve 54 are closed, and the air release valve 53, the recovery valve 55, and the bypass valve 56 are opened. That is, at the printing operation, the ink tank 32 is released to atmospheric pressure. During the printing operation, the ink tank 32 is not decreased in pressure, and substantial degassing does not occur. Every time when the ink is ejected from the recording head 21, the ink is supplied from the ink tank 32 to the recording head 21 through the bypass flow pass 46 and the recovery flow pass 45. In some cases, the ink is replenished in the middle of the ink replacement operation, the printing operation, and the like. During the ink replenishment operation, the replenishment valve 51 is opened and the replenishment pump 61 is driven. The ink is replenished from the ink container 31 to the ink tank 32 through the replenishment flow pass 41 by driving the replenishment pump 61.

FIG. 1 and the others are schematically drawn, and the recording head 21 is actually disposed above the ink tank 32. A negative pressure is applied to the ink in the recording head 21 by a head difference from the ink in the ink tank 32, and a meniscus is formed in the nozzle of the recording head 21 by the negative pressure. After the ink is ejected from the recording head 21, the surface tension of the ink acts to reduce the surface area of the meniscus, and the resulting negative pressure draws the reduced amount of the ink from the ink tank 32 into the recording head 21. The recovery valve 55 may be closed to supply the ink to the recording head 21 only from the bypass flow pass 46.

If the ink tank 32 is decreased in pressure to the extent that substantial degassing occurs in a state where the recording head 21 and the ink tank 32 are connected, the meniscus in the nozzle may be destroyed. Even if the meniscus is not destroyed, there is a risk that the shape of the meniscus in the nozzle changes from that when the ink tank 32 is released to the atmosphere, and the ejection characteristics of the ink may be changed. In the present embodiment, since the ink tank 32 is not decreased in pressure so as to cause the substantial degassing during the printing operation, the meniscus in the nozzle of the recording head 21 is not destroyed, and the shape is not changed and the ejection characteristic is not changed.

As described above, when a perista pump or a diaphragm pump is employed as the circulation pump 67, there is a problem that it is easily affected by the pressure decreasing.

For example, in the case of the perista pump, the liquid is fed by squeezing a soft tube made of silicone rubber or the like using a plurality of rollers. Here, if air enters the tube between the two rollers, a phenomenon in which the tube is crushed by the pressure decreasing, and on the other hand, the tube is expanded by releasing to the atmosphere occurs, and there is a risk that the tube will be damaged by repeated expansion and contraction of the tube over a long period of time.

In the case of a diaphragm pump, the liquid is fed by reciprocating the diaphragm using a swash plate or the like. Here, if air enters the diaphragm, a phenomenon in which the diaphragm is crushed by the pressure decreasing, and on the other hand, the diaphragm is expanded by releasing to the atmosphere occurs, and there is a risk that the diaphragm will be damaged by repeated expansion and contraction of the diaphragm over a long period of time.

Therefore, the degassing device 40 according to the present embodiment suppresses the effect of pressure decreasing by the following method. The degassing device 40 according to the present embodiment removes air dissolved in a liquid (for example, the ink) under a pressure decreased atmosphere, and includes the liquid tank (for example, the ink tank 32), the pressure decreasing device (for example, the pressure decreasing pump 62), the circulation flow pass 47, and the circulation device (for example, the circulation pump 67). The liquid tank stores the liquid. The pressure decreasing device decreases the pressure of the inside of the liquid tank. The circulation flow pass communicates different positions of the liquid tank. The circulation device circulates the liquid through the circulation flow pass 47. The circulation device is driven in at least one of timing before driving the pressure decreasing device and timing before releasing the pressure decreased liquid tank to the atmosphere. Specifically, they are as follows.

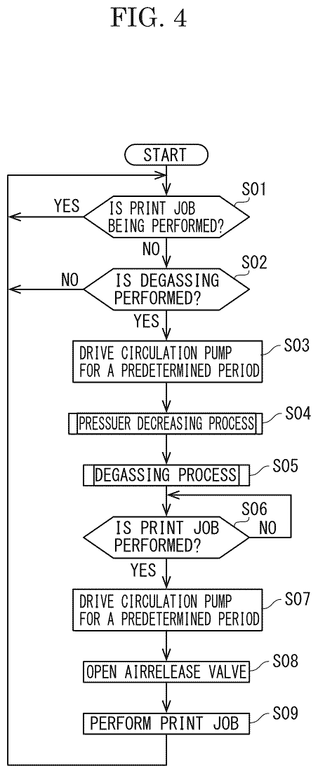

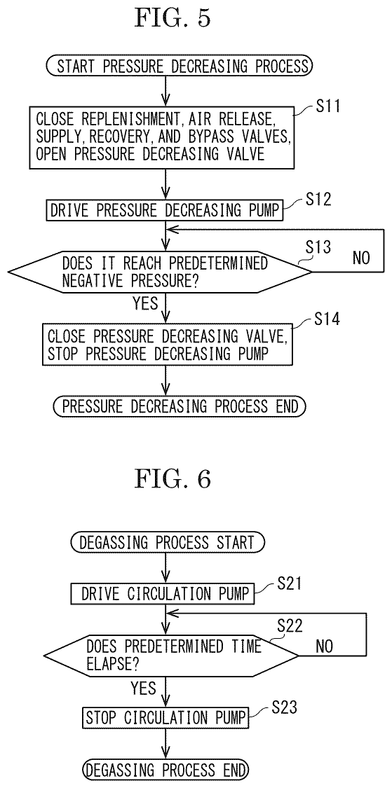

FIG. 4 is a flowchart explaining the total operation of the degassing device 40. FIG. 5 is a flowchart explaining the operation of the pressure decreasing process of the degassing device 40. FIG. 6 is a flowchart explaining the operation of the degassing process of the degassing device 40.

Here, the standby state will be described as an initial state. In the standby state, the replenishment valve 51, the pressure decreasing valve 52, and the supply valve 54 are closed, and the air release valve 53, the bypass valve 56, and the recovery valve 55 are opened. The ink is stored in the ink tank 32, and when the liquid surface is exposed to the air in the upper space 34 released to the atmosphere, the air is dissolved in the ink with the elapse of time. In the standby state, the control device 38 periodically repeats the operation shown in FIG. 4.

First, the control device 38 determines whether the print job is being performed (FIG. 4, step S01). If the print job is being performed (step S01: YES), the control device 38 repeats the determination in step S01. On the other hand, if the print job is not being performed (step S01: NO), the determination part 39 of the control device 38 determines whether the degassing operation is to be performed (step S02). For example, the control device 38 (see FIG. 2) is provided with a timer, and the time for leaving the ink is measured by the timer. The viscosity of the ink can be estimated from one or more parameters such as air pressure, temperature of the ink, time elapsed since the last printing, or the others. Therefore, the determination part 39 stores conversion information indicating the corresponding relationship between each parameter and the viscosity of the ink, and estimates the viscosity of the ink based on each parameter. The determination part 39 stores conversion information indicating the corresponding relationship between the viscosity of the ink and the allowable time, and sets the allowable time based on the viscosity of the ink. The allowable time is the time during which printing is allowed without degassing even if the ink is left.

When the time for leaving the ink is within the allowable time, since the oxygen saturation degree is low, the determination part 39 determines that the degassing is unnecessary, and the degassing operation is not performed. When the time for leaving the ink exceeds the allowable time, the determination part 39 determines that the degassing is necessary because the oxygen saturation degree is high, and the degassing operation is performed. Map data, lookup table, conversion equation, and the like are used for the conversion information indicating the corresponding relationship between each parameter and the viscosity of the ink and the conversion information indicating the corresponding relationship between the viscosity of the ink and the allowable time. These map data, lookup tables, and conversion formulas are obtained experimentally, empirically, and theoretically in advance.

If it is determined in step S02 that the degassing is not performed (step S02: NO), the control device 38 repeats the determination in step S01. On the other hand, when it is determined that the degassing is to be performed (step S02: YES), the control device 38 drives the circulation pump 67 for a predetermined time (step S03). In a case where air has entered the circulation pump 67 and the circulation flow pass 47, the air is removed by driving the circulation pump 67, and the circulation pump 67 and the circulation flow pass 47 are filled with the ink.

Next, the control device 38 performs the pressure decreasing process (step S04 of FIG. 4, see FIG. 5). Specifically, the control device 38 closes the replenishment valve 51, the air release valve 53, the supply valve 54, the recovery valve 55, and the bypass valve 56, and opens the pressure decreasing valve 52 (step S11). Next, the control device 38 drives the pressure decreasing pump 62 (step S12), and determines whether the pressure in the ink tank 32 indicated by the barometer 33 reaches a predetermined negative pressure (step S13). If it is determined that the air pressure does not reach the predetermined negative pressure (step S13: NO), the control device 38 repeats the determination in step S13 while driving the pressure decreasing pump 62. On the other hand, if it is determined that the air pressure reaches the predetermined negative pressure (step S13: YES), the control device 38 closes the pressure decreasing valve 52 and stops the pressure decreasing pump 62 (step S14). Since the air is removed by driving the circulation pump 67 in step S03, the load applied to the circulation flow pass 47 and the circulation pump 67 due to the decreased pressure is reduced. Since the circulation pump 67 is not driven in the pressure decreasing process, the re-dissolution of the air into the ink is suppressed.

Next, the control device 38 performs the degassing process (step S05 of FIG. 4, see FIG. 6). Specifically, the control device 38 drives the circulation pump 67 (step S21). When the circulation pump 67 is driven, the ink in the ink tank 32 is circulated through the circulation flow pass 47. The ink near the bottom surface of the ink tank 32 having a large amount of dissolved air flows out into the circulation flow pass 47 through the outlet port 71, and the ink in the circulation flow pass 47 flows into the vicinity of the liquid surface in the ink tank 32 through the inlet port 72. The liquid surface of the ink is exposed to the pressure decreased atmosphere to remove the air dissolved in the ink near the liquid surface. The degassing efficiency is improved by smoothly replacing the ink near the liquid surface having a small amount of dissolved air with the ink near the bottom surface having a large amount of dissolved air.

Next, the control device 38 determines whether a predetermined time elapses since the start of driving the circulation pump 67 (step S22). If it is determined that the predetermined time is not elapsed (step S22: NO), the control device 38 repeats the determination in step S22 while driving the circulation pump 67. On the other hand, when it is determined that the predetermined time elapses (step S22: YES), the control device 38 stops the circulation pump 67 (step S23). At the end of the degassing process, since all valves are closed, the pressure decreased state is maintained.

Next, the control device 38 determines whether the print job is to be performed (step 06 in FIG. 4). If it is determined that the print job is not performed (step S06: NO), the control device 38 repeats the determination in step S06. On the other hand, if it is determined that the print job is performed (step S06: YES), the control device 38 drives the circulation pump 67 for a predetermined time (step S07). In a case where air has entered the circulation pump 67 and the circulation flow pass 47, the air is removed by driving the circulation pump 67, and the circulation pump 67 and the circulation flow pass 47 are filled with ink.

Next, the control device 38 releases the air release valve 53 (step S08). Since the air is removed by driving the circulation pump 67 in step S07, the load applied to the circulation flow pass 47 and the circulation pump 67 due to the air releasing is reduced. Since the circulation pump 67 is not driven, the re-dissolution of air into the ink is suppressed. Next, the control device 38 performs the print job (step S09) and repeats the processes from step S01.

According to the degassing device 40 according to the present embodiment described above, the degassing device 40 removes air dissolved in the liquid (for example, the ink) under a pressure decreased atmosphere, and includes the liquid tank (for example, the ink tank 32), the pressure decreasing device (for example, the pressure decreasing pump 62), the circulation flow pass 47, and the circulation device (for example, the circulation pump 67). The liquid tank stores the liquid. The pressure decreasing device decreases the pressure of the inside of the liquid tank. The circulation flow pass 47 communicates different positions of the liquid tank. The circulation device circulates the liquid through the circulation flow pass 47. The circulation device is driven in at least one of timing before driving the pressure decreasing device and timing before releasing the pressure decreased liquid tank to the atmosphere. According to this configuration, in a case where air has entered the circulation device and the circulation flow pass 47, the air is removed by driving the circulation device, and the circulation device and the circulation flow pass 47 are filled with the liquid. Therefore, according to the present embodiment, the load applied to the degassing device 40 due to the decreased pressure can be reduced.

According to the degassing device 40 according to the present embodiment, the circulation device is not driven during the period when the pressure decreasing device is driven. According to this configuration, the re-dissolution of air into the liquid can be suppressed.

Further, according to the degassing device 40 according to the present embodiment, the circulation device is not driven during the period when the pressure decreased liquid tank is released to the atmosphere. According to this configuration, the re-dissolution of air into the liquid can be suppressed.

According to the degassing device 40 according to the present embodiment, at least one of the circulation flow pass 47 and the circulation device includes a flexible member. According to this configuration, the deterioration of the flexible member can be suppressed.

According to the degassing device 40 according to the present embodiment, the circulation device is a perista pump or a diaphragm pump. According to this configuration, deterioration of the tube of the perista pump and the diaphragm of the diaphragm pump can be suppressed.

The inkjet recording apparatus 1 according to the present embodiment is provided with the degassing device 40 and the recording head 21 which ejects the liquid degassed by the degassing device 40 to the sheet S. According to this configuration, the deterioration of image quality caused by the generation of bubbles can be suppressed.

The above embodiment may be modified as follows.

In the above embodiment, an example in which the degassing device 40 is provided in the inkjet recording apparatus 1 is shown, but the degassing device 40 can also be applied to devices used in other fields such as semiconductor manufacturing fields and display manufacturing fields. That is, it can be applied to degassing of chemical solutions, electrolytic solutions, liquid resins, adhesives, solvents, lubricating oils, liquid foods, serum, or the like, other than the ink.

In the above embodiment, an example in which the pressure decreasing pump 62 is used as a pressure decreasing device is shown, but the pressure decreasing device may be a device capable of reducing pressure in the ink tank 32, and for example, the pressure decreasing device may be an ejector.

1. A degassing device which removes air dissolved in liquid under a pressure decreased atmosphere, the degassing device comprising:
a liquid tank in which the liquid is stored;
a pressure decreasing device which decreases pressure in the liquid tank;
a circulation flow pass which communicates different positions of the liquid tank;
a circulation device which circulates the liquid through the circulation flow pass; and
a control device which drives the circulation device at least one of timing before driving the pressure decreasing device and timing before releasing the pressure decreased liquid tank to the atmosphere.

2. The degassing device according to claim 1, wherein,
the circulation device is not driven during a period where the pressure decreasing device is driven.

3. The degassing device according to claim 1, wherein,
the circulation device is not driven during a period where the pressure decreased liquid tank is released to the atmosphere.

4. The degassing device according to claim 1, wherein,
at least one the circulation flow pass and the circulation device includes a flexible member.

5. The degassing device according to claim 4, wherein
the circulation device is a perista pump or a diaphragm pump.

6. An inkjet recording apparatus comprising:
the degassing device according to claim 1, and
a recording head which ejects the liquid degassed by the degassing device, to a sheet.
